(19) United States
(12) Patent Application Publication
(10) Pub. No.: US 2025/0345776 A1
(43) Pub. Date: Nov. 13, 2025

(54) Porous composite and use thereof for gas storage

(71) Applicants: Université de Pau et des Pays de l'Adour, PAU (FR); Centre national de la recherche scientifique, PARIS (FR); Institut National Polytechnique de Toulouse, TOULOUSE (FR); UNIVERSITE TOULOUSE III-Paul Sabatier, TOULOUSE CEDEX 9 (FR)

(72) Inventors: Christelle MIQUEU, BIDACHE (FR); Laurent PERRIER, MOUGUERRE (FR); Jean-Philippe TORRE, MONTAUBAN (FR); Alex PENNETIER, RENNES (FR)

(21) Appl. No.: 18/866,595

(22) PCT Filed: May 15, 2023
(86) PCT No.: PCT/EP2023/062983

§ 371 Date: Nov. 18, 2024

(30) Foreign Application Priority Data
May 20, 2022 (FR) FR2204851

(51) Int. Cl. B01J 20/28; B01J 20/32; C01B 3/00

(52) U.S. Cl. CPC B01J 20/28083; B01J 20/3204; B01J 20/321; B01J 20/3248; C01B 3/0078

(57) ABSTRACT

The present application relates to the storage of gases, using a porous composite based on a porous matrix and an organic compound confined in solid form within pores of the matrix with a diameter of less than 10 nm.

The present disclosure concerns the field of energy storage and in particular the storage of gases such as dihydrogen (H₂).

Hydrogen lies at the core of tomorrow's ecological transition and is anticipated to be one of the fuels of the future. Political leaders and major energy players take a strong stance in this respect. The means for storing H₂ in the Hydrogen energy chain are a major obstacle to large-scale deployment of this form of energy.

There are different types of hydrogen storage such as conventional tanks for example (in gaseous or liquid form) and in solid form (in adsorbed, absorbed, or trapped form). None of these techniques currently give full satisfaction for stationary or mobile storage whether for reasons of insufficient performance, safety, social acceptably or profitability.

Storage in solid form is currently obtained:
either by adsorption in porous matrices, but storage capacities only prove to be of advantage at very low temperature, in particular at cryogenic temperature (77K),
or by absorption in metal or complex hydrides. While some of these do have a volume density of storage that is advantageous (higher than that of liquid hydrogen) and even if the pressures involved are moderate, the use of these types of materials comes up against two major shortcomings: the kinetics of hydride formation and dehydriding are slow and dehydriding temperatures are high (above 300° C. and 480° C. for MgH₂ and LiBH₄ respectively).

FR 3000907 describes a reactive medium comprising a porous substrate on which there is deposited an organic compound in solid form capable of forming gas clathrates, the porous substrate having pores of size between 10 nm and 150 nm, preferably between 30 nm and 120 nm. After being impregnated via liquid process the organic compound in solid form is deposited on the surface and/or within the pores of the substrate. The gas can be captured by the organic compound in the form of clathrates.

This technique has the disadvantage of using solvents requiring steps of dissolution, filtration and drying.

There therefore remains a need to provide a technique for storing dihydrogen having storage capacities of interest and allowing storage and release of the gas under undemanding conditions.

These objectives in particular are achieved with the present invention.

The present invention therefore concerns a porous composite for storing gas, comprising:
a porous matrix comprising pores having a diameter of less than 10 nm, and
an organic compound,
   said porous composite being characterized in that said organic compound is contained within said pores of diameter less than 10 nm.

In the meaning of the present invention, by the term «composite» it is meant a system composed of at least two materials, namely a porous matrix and an organic compound.

By the term «porous matrix», it is meant a solid material comprising pores within which an organic compound can be deposited.

Porous matrices suitable for the invention are those able to be used in industrial processes, in particular for the storage and use of stored gases, and in particular which do not deteriorate under the conditions of temperature and/or pressure applied in these processes.

Advantageously, the porous matrix is chosen from among organic or mineral micro- and/or mesoporous substrates, in particular those able to form inclusion compounds and more particularly silica, carbon, alumina, aluminosilicates, activated carbons, molecular sieves, zeolites, Metal Organic Frameworks (MOFs), Hofmann clathrates and polymers.

By «inclusion compound» it is meant a supramolecular structure in which one of the components (host molecule) forms a cavity within which the molecular entity or entities of a second chemical species (guest molecule) are stabilised. The concept includes solids (crystalline or amorphous) having a network with interstices (in the form of tunnels, channels of various shapes) able to confine an included species. The stabilisation of the guest molecules within the network formed by the host molecules is generally ensured by bonds of non-covalent type e.g. van der Waals forces. If the interstices formed in the host network are surrounded on every side so that the included species is «trapped» as in a cage, the inclusion compound can be called a “clathrate” or “cage compound”. The notion of inclusion compound as defined also comprises structures of “‘inclusion complex” type, in which the interactions involved to stabilise the guest molecules within the host network can be stronger than van der Waals bonds (e.g. hydrogen bonds).

Preferably, the porous matrix can be chosen from among the mesoporous silicas MCM-41 and SBA-15, aluminosilicates, carbon xerogels, activated carbons and porous polymers.

According to IUPAC nomenclature, «mesoporous» refers to pores having a diameter of between 2 and 50 nm, and « microporous » refers to pores having a diameter of less than 2 nm.

Pore size can be measured by gas porosimetry using nitrogen or argon as probe molecule. In this technique, the adsorption isotherm of the probe molecule is measured at cryogenic temperatures (generally 77K for nitrogen and 87K for argon) at pressures ranging from 10⁻⁷ bar to 1 bar. Thermodynamic models, preferably Density Functional Theory (DFT), are used to infer the pore volume and pore size distribution of porous matrixes from these isotherms.

In one embodiment, the matrix comprises a micro- or meso-porous volume, i.e. a volume defined by micropores and mesopores.

Therefore, in one embodiment, the pores of the porous matrix of diameter less than 10 nm represent at least 30%, preferably at least 50%, of the micro-/mesoporous volume of the porous matrix. This percentage being determined experimentally by a combination of analyses conducted by gas porosimetry (allowing characterization of pores of diameter less than 30 nm), by mercury porosimetry (allowing characterization of pores of diameter between 30 nm and several hundred micrometres), and by pycnometry (allowing evaluation of total porous volume).

Typically, particles of porous matrix are used, such as beads, grains, pellets or tissues for example, in particular silica beads or pellets, or activated carbon grains, pellets or tissues. Preferably porous particles of small size are chosen having a characteristic size (diameter for a spherical particle, cylinder height for a pellet) varying for example between 30 um and 10 mm.

In one embodiment, the porous matrix has a high specific surface area, in particular between 200 m²/g and 3000 m²/g.

The organic compound is chosen from among compounds able to form hydrogen bonds.

In one embodiment, said bonds can be qualified as <intermolecular >in that they are formed between an organic compound molecule and another molecule, typically between at least two molecules of the organic compound, or between a molecule of the organic compound and a molecule of the stored gas (e.g. hydrogen).

Therefore, suitable organic compounds comprise one or more electronegative atoms carrying at least one non-binding doublet such as oxygen O, nitrogen N, fluorine F, chlorine Cl, bromine Br, iodine I.

In one embodiment, the organic compound can particularly be chosen from among polyphenols, polythiols, ureas, thioureas and calixarenes. In particular, said organic compound can be chosen from the group formed by hydroquinone, resorcinol, fluorohydroquinone, 2-5 dihydroxyl-pyridine, catechol, urea, thiourea, calix[4]arene, and mixtures thereof.

Preferably, the organic compound is hydroquinone, urea, calix[4]arene.

In one embodiment, said organic compound is in condensed form within the pores. In one embodiment, said organic compound can be crystalline, semi-crystalline and/or amorphous form within the pores of the porous matrix.

In the invention, the organic compound can be deposited in pores of small size, in particular pores having a diameter of less than 10 nm.

Preferably, said organic compound occupies a large portion of the pores of the porous matrix, and in particular the micropores and mesopores of the porous matrix. Therefore, in one embodiment, said organic compound occupies at least 25%, preferably at least 40% of the micro-and mesoporous volume of the porous matrix.

In one embodiment, the organic compound can up to the entirety of the porous volume of the porous matrix.

The volume percentage of the pores occupied by said organic compound can be determined by gas porosimetry.

A further subject of the invention concerns a process, via dry process, for preparing a porous composite of the invention, said process comprising the diffusion or organic vapours in the porosity of said porous matrix, followed by adsorption/condensation of said organic compound within the pores of said porous matrix.

The process of the invention is performed «via dry process» i.e. without solvent.

The term «adsorption/condensation» refers to the change in state of the organic compound throughout the process.

Without wishing to be bound by any theory, the physical mechanism of incorporation of the organic compound stems from adsorption, in particular via physisorption, even chemisorption, particularly involving the formation of bonds of hydrogen or van der Waals type, and from simultaneous condensation of the gas phase, hereinafter called adsorption/condensation.

In one embodiment, condensation of the organic product takes place inside the pores of the porous matrix

More particularly, the organic compound in gaseous form is condensed when adsorbed in the pores of the matrix.

In the composite of the invention, the organic compound confined within the pores is therefore in condensed form.

The organic compound here can indifferently be termed « impregnated», «condensed» or «confined» and designates a homogeneous or non-homogeneous, solid and/or liquid state.

In one embodiment, the organic compound in gaseous form can be obtained from the solid form thereof via sublimation.

In one embodiment, said process may therefore also comprise a prior sublimation step of said organic compound from the solid phase to the gaseous phase. This sublimation step can typically be conducted at reduced pressure, under heating, for example in a vacuum and at a temperature of between 50 and 250° C.

In one embodiment, the confining of hydroquinone can be conducted by vacuuming for sublimation thereof, in particular at a temperature of between 80 and 170° C., followed by return to ambient temperature.

Therefore, the organic compound sublimated to the gaseous state enters the pores of the porous matrix where it is condensed/adsorbed in condensed form.

Said organic compound can therefore be confined in the pores, after condensation, without undergoing decomposition or degradation.

The present invention also concerns a porous composite able to be obtained with the above-described process.

In the invention, the composite so obtained has the particular aspect of comprising a condensed organic compound confined within the pores of diameter less than 10 nm of a porous matrix.

The above-described porous composite allows the storing of gases. A further subject of the invention therefore concerns a gas storage method, said method comprising:
contacting the porous composite of the invention with the gas to be stored or mixture comprising said gas;
applying one or more successive temperature cycles.

Typically, storage is obtained via capturing of the gas by the organic compound confined within the meso-or micropores of the matrix. The capture followed by retention of the gas are generally obtained by means of weak bonds e.g. of van der Waals type, that are set up between the atoms of said organic compound and the hydrogen atoms of the gas.

The expression «temperature cycle» used herein is to be understood as the successive passing from a temperature T1 to a temperature T2, such that T1<T2.

In one embodiment, T1 can be chosen among temperatures higher than or equal to 77 K, in particular 0° C.

In one embodiment, T2 can be chosen among temperatures lower than the desorption temperature of the condensed organic compound, in particular in the region of 100° C.

The pressure applied for these cycles can be between 1 and 200 bar for example, preferably between 5 and 150 bar, advantageously between 20 and 120 bar.

One or more cycles can be successively applied. The number of cycles can vary as a function of the type of matrix and organic compound. In general, a sufficient number of cycles is applied when the amount of incorporated organic compound reaches a plateau. This amount can be determined by measurements of quantities of adsorbed gases, for example using gravimetric or volumetric techniques.

Advantageously, the composite of the invention allows the storing of dihydrogen.

A further subject of the invention concerns the system, composed of the composite incorporating the stored gas, able to be obtained with the process of the invention.

The invention therefore also concerns a gas storage device comprising the porous composite of the invention and a gas, said gas being stored within the pores comprising the organic material.

Advantageously, the storage is stable under normal conditions of temperature and pressure e.g. at 25° C./1 bar or at 0° C./1 bar (NTP).

A further subject of the invention concerns the use of this device, comprising the removal of said gas from storage at ambient pressure and at a temperature lower than 150° C.

Removal of gas from storage is obtained by release of the gas. This step is conducted at a temperature dependent on the type of organic compound. Typically, gas release is conducted at a temperature lower than the desorption temperature of the condensed organic compound.

Advantageously, for hydrogen, the removal of dihydrogen from storage can be conducted at ambient pressure and at a temperature lower than or equal to 150° C., in particular lower than 100° C.

A still further subject of the invention is the use of a porous composite of the invention for storing gas, dihydrogen in particular.

The storing of gas in the porous composite of the invention has the advantage of being reversible. If the gas is removed from storage, the organic compound remains confined within the pores and can again be used to capture gas in the same manner as the preceding capture reaction. In particular, the capture reaction of dihydrogen is reproducible in terms of quantity of captured gas. The composite of the invention can therefore be reused once the gas has been desorbed.

A further subject of the invention concerns the use of the storage device of the invention for the purpose of using the gas stored therein. In the invention, the use therefore comprises the step of releasing said gas. Typically release from storage can be conducted at a temperature lower than temperature T2 mentioned above. For hydroquinone, release from storage can be conducted at a temperature lower than 150° C., in particular lower than 100° C.

The invention will be better understood on reading the following description given solely as an example and with reference to the appended drawings in which:

### FIGURES

FIG. 1 gives a schematic of the impregnation device.

FIG. 2 gives the results obtained after impregnation of different porous matrices with hydroquinone (HQ). (A): Impact of impregnation time on weight percentage (%) of impregnated HQ for 3 carbon matrices (1 fibrous matrix named «tissue» and 2 activated carbons), 3 mesoporous matrices in silica and a porous polymer. (B): TGA/DSC analysis showing that HQ is contained inside the pores of MCM-41 silica (peak offset compared with solid HQ). (C): Analysis of pore volume by argon porosimetry at 87 K, before (grey curve) and after impregnation with HQ (impregnation time: 8h) (black curve): 80% of the pore volume is occupied by HQ. (D): Pore size distribution by argon porosimetry at 87K before (grey curve) and after impregnation with HQ (black curve).

FIG. 3 illustrates the trend in weight percentage of captured H₂ (per total weight of material) as a function of temperature cycles varying between 0 and 100° C. for MCM-41 impregnated with HQ (with an impregnation time of 8 h) (P=20 bar).

FIG. 4 gives the weight percentage of captured H₂ (per total weight of material) as a function of temperature cycles varying between 0 and 100° C. for beads of porous polymer (with an impregnation time of 14 h) impregnated with HQ (P=20 bar).

FIG. 5 gives the comparison of variation in the quantity of stored hydrogen per weight of total sample (matrix+HQ) as a function of the number of cycles at 0° C., between the MCM41 substrate and comparative SF300A substrate.

FIG. 6 gives the comparison of variation in the quantity of stored hydrogen, per weight of HQ impregnated in the matrices, for the MCM41 substrate and comparative substrate SF300A.

FIG. 7 gives the curve obtained by TGA showing the variation in mass of the porous substrate alone (MCM41) and of the substrate after impregnation with calix[4]arene.

FIG. 8 gives the curves of accumulated volumes obtained by argon porosimetry at 87 K (IQ-Quantachrome-Anton Paar) for the matrix (PSP) before impregnation with urea and after impregnation (weight percentage of impregnation 13%).

FIG. 9 illustrates the H₂ storage capacity of the matrix PSP impregnated with 13% urea over temperature cycles of 0-100° C. per gram of composite.

FIG. 10 illustrates the H₂ storage capacity of MCM41 impregnated with 18% calix[4]arene over the temperature cycles, compared with the composite MCM41+HQ.

### EXAMPLES

### Preparation of the Porous Composite

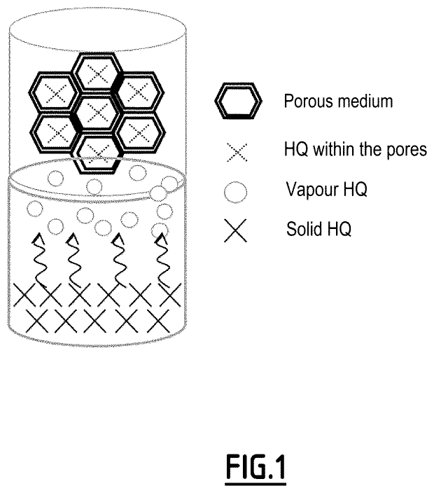

The protocol is illustrated in FIG. 1:
1—Between 1 and 5 g of solid organic compound (hydroquinone, HQ) is placed in a crucible above which there is positioned another crucible containing the porous matrix to be impregnated (between 200 and 1000 mg) previously purified in a low vacuum at an adapted temperature (200° C. for carbons, 300° C. for silicas and 120° C. for the polymer) according to material.
2—The two crucibles are separated by a Durapore filter of porosity 0.45 μm.
3—The assembly is placed in a vacuum oven at 120° C. for a time of between 1 and 64 hours so that the HQ is sublimated and is adsorbed in crystalline, semi-crystalline and/or amorphous form inside the pores of the upper-positioned matrix. The impact of impregnation time is analysed.
4—The system is then cooled (controlled temperature ramp) and returned to atmospheric pressure.

### Impregnation Results:

The protocol was tested on carbon and silica micro/mesoporous adsorbents:
1: Tissue
2: G-Bac
3: F400
4: Porous polymer
5: MCM-41
6: SBA-15
7: Si—Al

Tissue (PICA woven activated carbon by PICY Company, Levallois, FRANCE), G-bac (by Kureha®) and F400 (Filtrasorb®400 by Calgon Carbon Corporation) are carbon matrices. MCM-41, SBA-15 and Si—Al are silica matrices referenced under these names.

The porous polymer is Optipore by Dow Chemicals (recently referenced by Dupont).

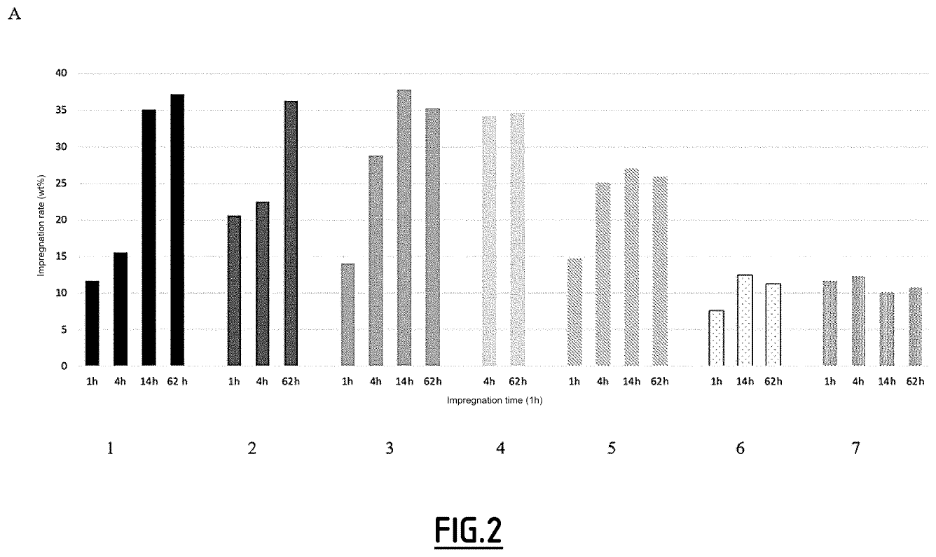

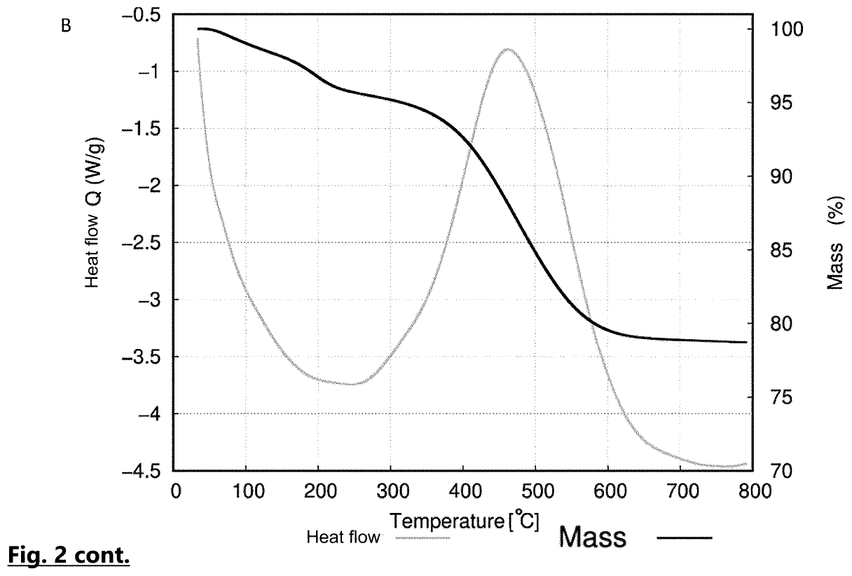

The organic product used is hydroquinone (purity >99.5%, supplied by Acros Organics). The maximum impregnation rates are reached after a few hours and are between 12 and 38 weight % depending on substrate. FIG. 2A illustrates the results obtained for the different above-identified matrices 1-7.

SEM, TGA/DSC analyses, and characterizations by gas porosimetry showed that the HQ was well impregnated within the porosity (cf. FIG. 2).

### H₂ Capture Tests

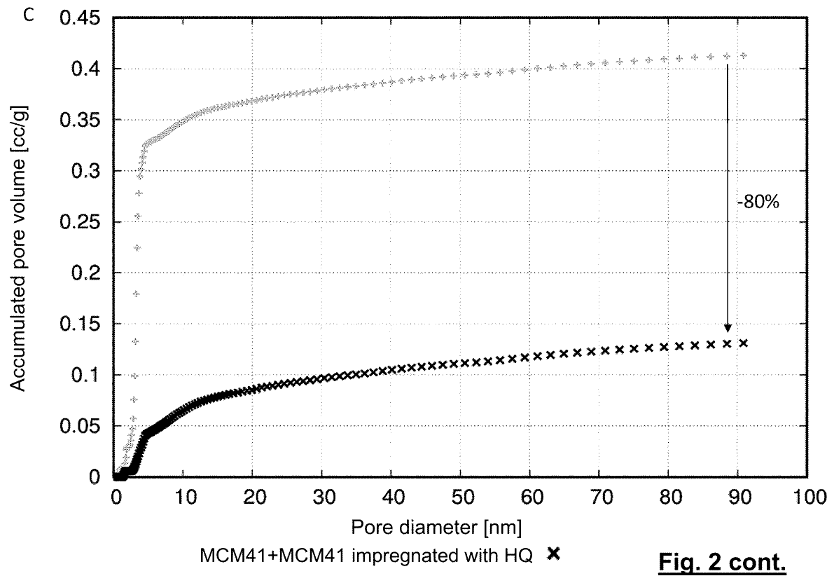

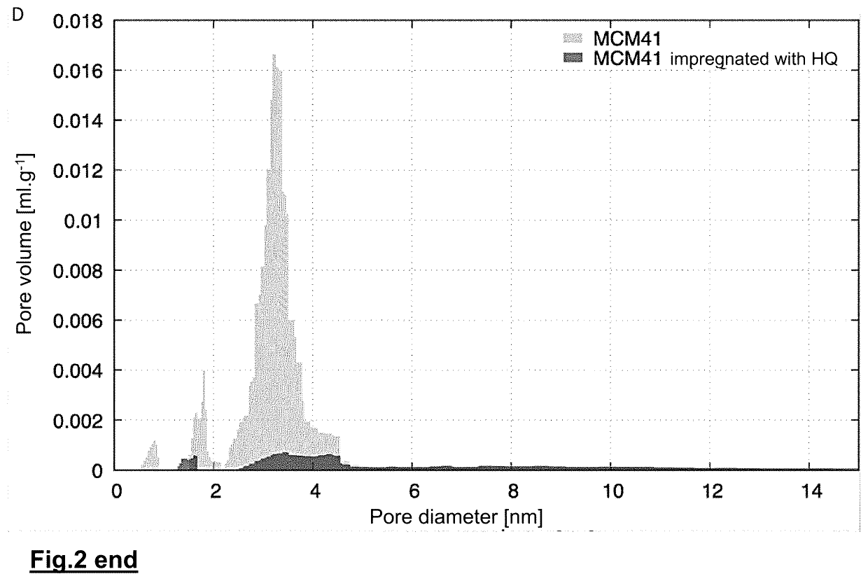

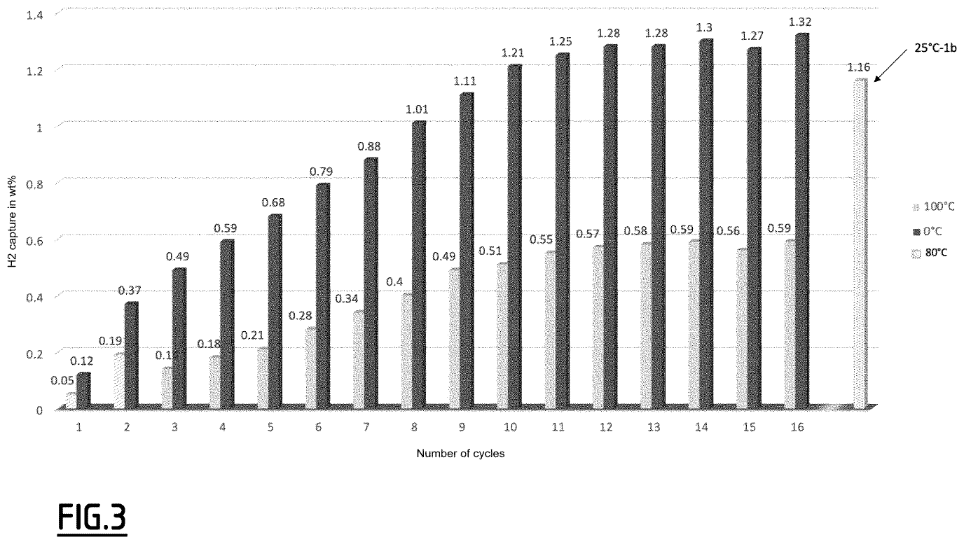

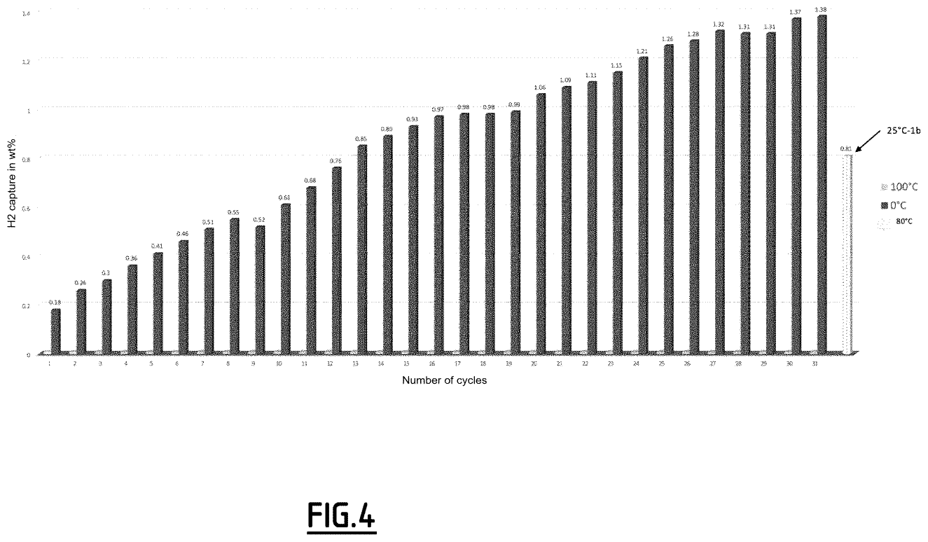

H₂ capture tests were performed via gravimetric technique using a magnetic suspension balance (Rubotherm).
The impact of temperature and pressure was analysed. An exhaustive study of the hybrid MCM-41/HQ material gave the following results:
   a first rise in temperature is needed to «activate» the system, 80° C. for MCM-41,
   successive temperature cycles, (from 0° C. as minimum temperature to 100° C. as maximum temperature for the example given in FIG. 3 i.e. MCM-41/HQ, first allow capture/release of H₂ and secondly allow a maximum capture rate to be reached after about ten cycles;
   the compound remains stable at ambient pressure for a least 48 h;
   for the MCM-41/HQ system, the weight percentage of H₂ obtained at atmospheric pressure and at 25° C. (FIG. 3) is about 1.2% per total weight of impregnated material i.e. 5.7% per weight of HQ.
Capture tests on a very different porous matrix (polystyrene porous polymer, Optipore by Dow Chemicals) gave very similar results (FIG. 4), which appears to show a large variability in the nanoporous matrices (in terms of chemical type and pore size) able to be used.

### Comparison With Existing Solid H₂ Storages:

The H₂ capture rate obtained, per weight of composite (1.2%) or per weight of HQ (5.7%) lies within the average for existing methods, with reference to the classification of different existing solid storages reported by Gupta et al., Energy Storage Materials, vol. 41, p. 69-107, October 2021.

Nonetheless, the system of the invention has the considerable advantage of operating at ambient temperature and at moderate temperatures (1 bar, 25° C.), together with lower cost and better stability compared with hydrides in particular.

### Comparative Test

Tests were also performed on porous particles of silica, SiliaFlash SF300A (supplier Silicycle) having a diameter of between 200 and 500 microns (same particles as those used in the article by Coupan et al. (Chemical Engineering Journal 2017, 325, 35-48).
Drying of the SF300A particles (purification) for 24 h at 110° C. Cooling in a desiccator followed by placing in an oven in a closed container at 35° C.
Hydroquinone/ethanol impregnation solution: 7 g of hydroquinone are placed in an Erlenmeyer. The total weight is adjusted to 20 g with absolute ethanol. The Erlenmeyer is closed, placed under magnetic stirring then heated in an oven at 35° C. until complete dissolution of the crystals in the solvent (clear solution).
3 grams of SF300A silica particles (held at 35° C.) are placed in a glass flask and covered with a sufficient quantity of HQ/ethanol impregnation solution (at 35° C.) until all the particles are fully immersed. The flask containing the silica particles and impregnation solution is shaken manually, sealed, and left in the oven at 35° C. for 24 h.
after a contact time of 24 h between the silica particles and impregnation solution, the particles impregnated with liquid are filtered on a Bushner filter connected to a vacuum flask, recovered in a crystallizer, and oven dried at 35° C. for 24 h.

The resulting SF300A/HQ composites are in the form of a uniform white powder (no black or grey particles, no clusters, no plaques) perfectly dry.

The impregnation rate of these composites measured by TGA is 32 mass % of HQ.

After drying, the composite particles were packaged in a glass flask with sealed stopper, in air and at ambient temperature. They were kept in this flask until testing on the magnetic suspension balance.

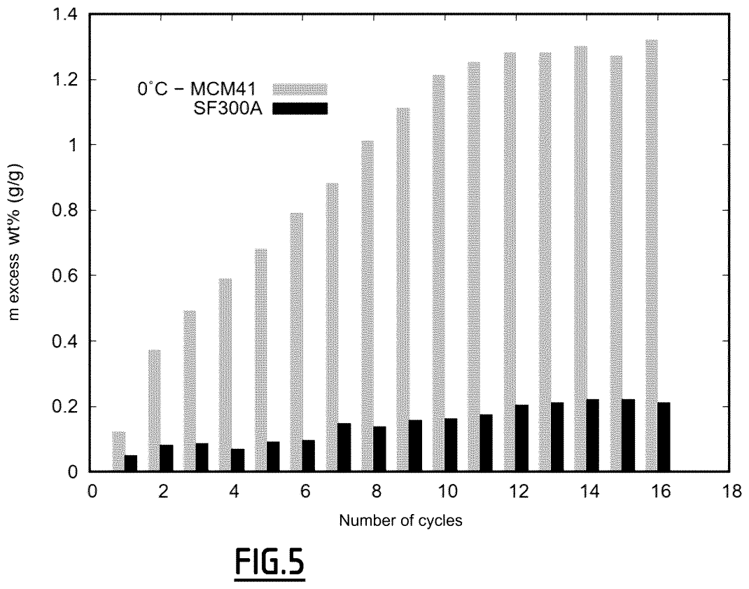

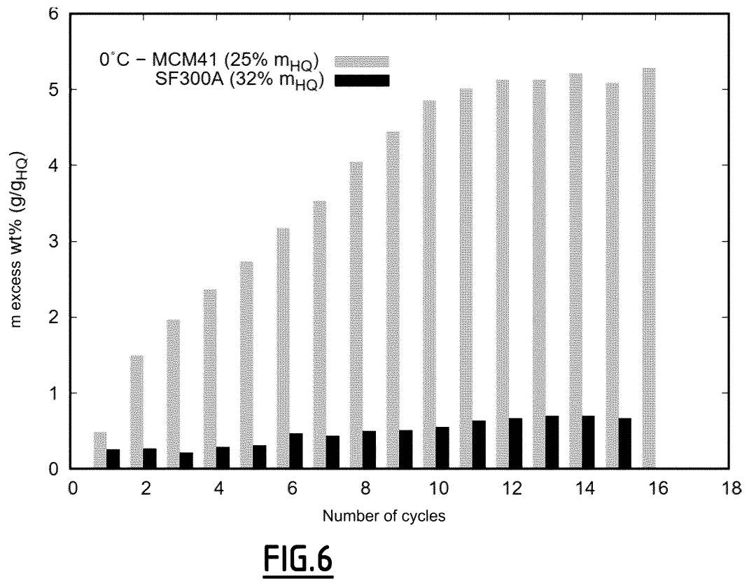

The composite was tested for hydrogen storage. The same capture protocol was followed, namely temperature cycles between 0° C. and 100° C., at a pressure of 20 hydrogen bar. The results are given in FIGS. 5 and 6, giving a comparison of H₂ capture cycles with MCM41+HQ, having a mean pore size of 3 nm but a surface chemistry comparable to that of SF300A.

In FIG. 5, the quantity of stored hydrogen per total weight of sample (matrix+HQ) is plotted as a function of the number of cycles at 0° C. (the quantities are zero at 100° C. for SF300A+HQ).

The stored quantities of H₂ for the MCM41+HQ sample are ten times higher than those for SF300A after about ten cycles.

In FIG. 6, the stored quantities are expressed per weight of HQ impregnated in the matrices. They are 7 times higher in MCM41+HQ.

These results show that when HQ is impregnated in pores of small size (smaller than 10 nm), the stored quantities are much higher as a result of the confinement effect in pores of this size.

### Impregnation and Capture With Calixarene

Impregnation was also carried out with calix[4]arene (CX4) in the porous substrate MCM41, by sublimation of CX4 at 300° C. under a high vacuum for 72 h.

An impregnation weight percentage of 16% was obtained.

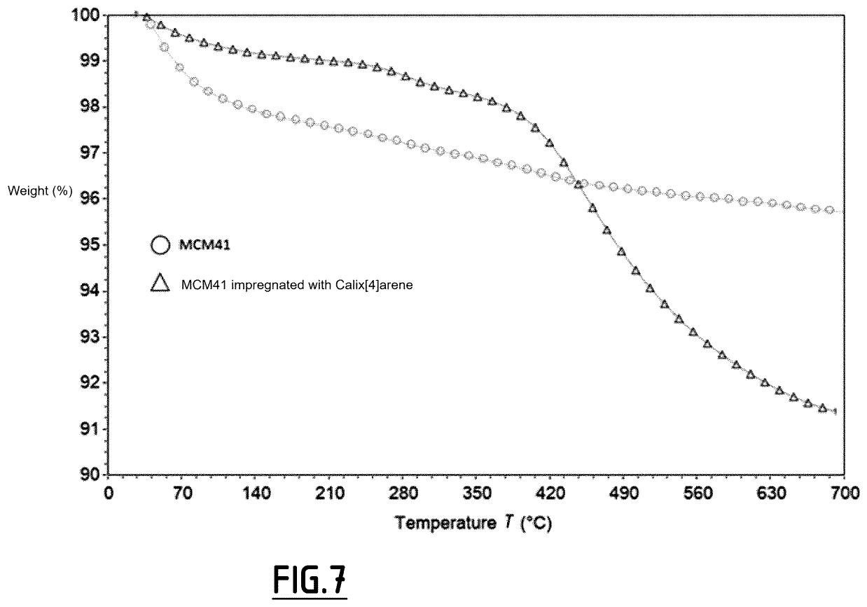

The TGA results in FIG. 7 confirm the presence of CX4 in the nanoporosity. Pure (non-confined) CX4 has a melting point in the region of 310-315° C. (verified by TGA), while the main mass loss takes place after 420° C. This offset towards the higher temperatures indicates that the CX4 is present in the nanoporosity as shown for HQ in FIG. 2(B).

The hydrogen capture test was conducted with the MCM41 porous substrate impregnated with calix4arene at 18 weight %.

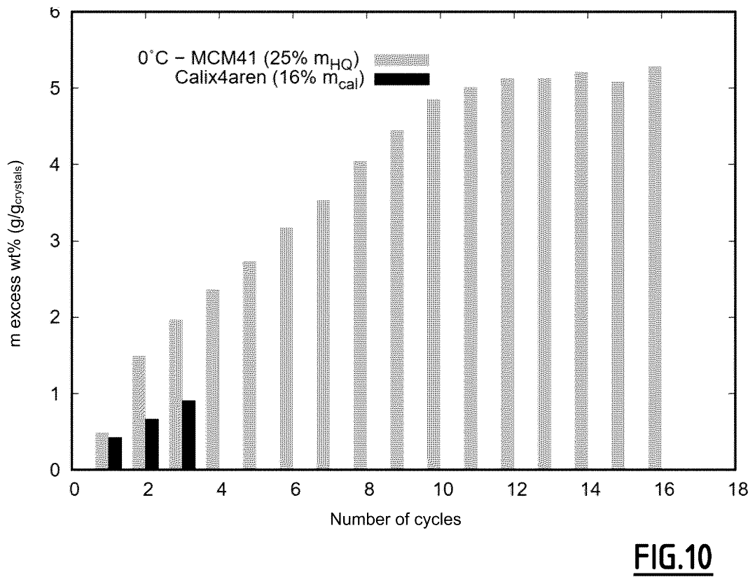

The hydrogen capture results for the first 3 cycles are given in FIG. 10.

In this Figure, the weight of captured hydrogen for the composites MCM41+HQ and MCM41+Calix4arene are compared.

The capacities are expressed per mass of crystals. For the first 3 cycles, the trend is effectively similar to that of HQ, namely an increase as a function of cycles.

### Impregnation and Capture With Urea

Impregnation and pore occupation tests (pore diameter less than 10 nm) were also conducted with urea following the above protocol for HQ (FIG. 1) on a matrix PSP. An impregnation rate of 13% was obtained.

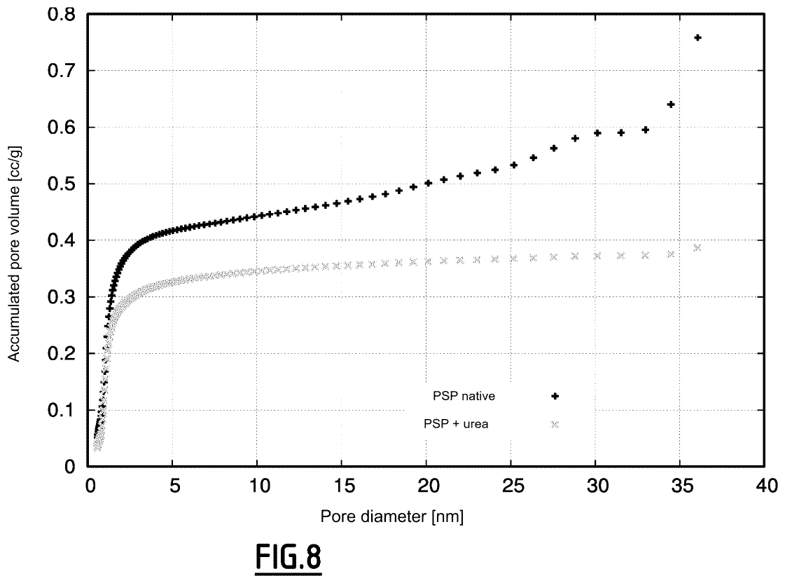

The results are given in FIG. 8 in which the boxed % corresponds to the percent volume, in pores of size less than 10 nm in the initial matrix, which was lost after impregnation, in other words which was filled with urea (here 20%).

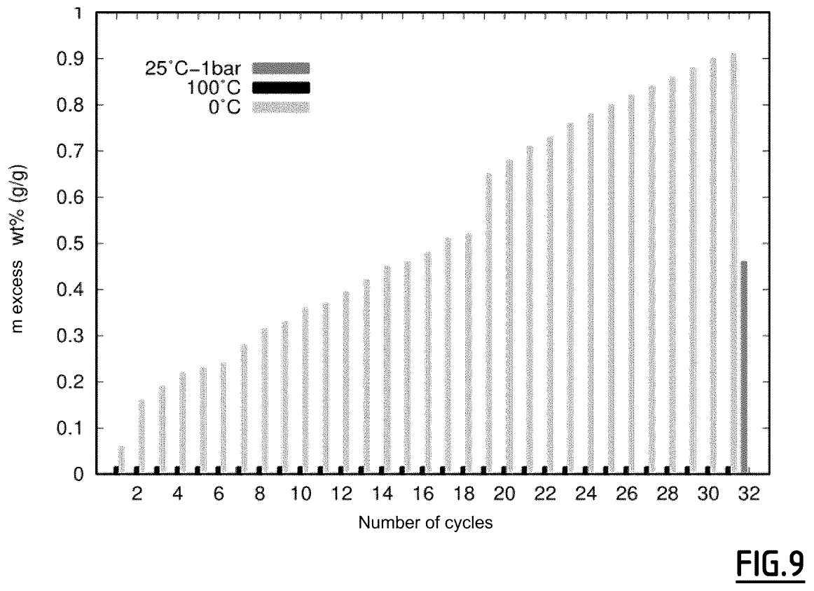

Dihydrogen capture tests were also performed with the resulting composite: the results are given in FIG. 9.

1. A porous composite for gas storage, comprising:
a porous matrix comprising pores having a diameter of less than 10 nm, and
an organic compound,
said porous composite being characterized in that said organic compound is contained within said pores of diameter less than 10 nm.

2. The porous composite according to claim 1, such that the pores of the porous matrix of diameter less than 10 nm represent at least 30%, preferably at least 50% of the micro-/mesoporous volume of the porous matrix.

3. The porous composite according to claim 1, such that the organic compound is chosen from among compounds able to form intermolecular hydrogen bonds.

4. The porous composite according to claim 1, such that said organic compound is chosen from among the following compounds: polyphenols, polythiols, ureas, thioureas and calixarenes.

5. The porous composite according to claim 1, such that said organic compound is chosen from among hydroquinone, resorcinol, fluorohydroquinone, 2-5 dihydroxyl-pyridine, catechol, urea, thiourea, calix[4]arene.

6. The porous composite according to claim 1, such that said organic compound is contained in crystalline, semi-crystalline and/or amorphous form within the pores.

7. The porous composite according to claim 1, such that the porous matrix is chosen from among organic or mineral micro-and/or mesoporous substrates such as silica, carbon, alumina, aluminosilicates, activated carbons, molecular sieves, zeolites, Metal Organic Frameworks (MOFs), Hofman clathrates and polymers.

8. The porous composite according to claim 1, such that the porous matrix is chosen from among mesoporous MCM-41 and SBA-15 silicas, aluminosilicates, carbon xerogels, activated carbons and porous polymers.

9. The porous composite according to claim 1, such that the organic compound occupies at least 25%, preferably at least 40% of the micro-and mesoporous volume of the porous matrix.

10. A dry process for preparing a porous composite according to claim 1, comprising the adsorption/condensation of said organic compound in gaseous phase within the pores of said porous matrix.

11. The process according to claim 10 comprising the prior sublimation step of said organic compound, from the solid phase to the gas phase.

12. A gas storage method, comprising:
contacting the porous composite according to claim 1 with the gas to be stored, or a mixture comprising said gas;
applying one or more successive temperature cycles.

13. The method according to claim 12, such that the gas is dihydrogen.

14. A gas storage device comprising the porous composite according to claim 1, and additionally comprising a gas, said gas being stored within the pores comprising the organic material.
